(19) United States
(12) Patent Application Publication
(10) Pub. No.: US 2022/0112092 A1
(43) Pub. Date: Apr. 14, 2022

(54) METHOD OF CONTROLLING THE ELECTRICAL PROPERTIES OF MAGNETITE PARTICLES

(71) Applicant: DAVID LUSSEY, Richmond North Yorkshire (GB)

(72) Inventor: DAVID LUSSEY, Richmond North Yorkshire (GB)

(21) Appl. No.: 17/417,635

(22) PCT Filed: Dec. 23, 2019
(86) PCT No.: PCT/GB2019/053691

§ 371 Date: Jun. 23, 2021

(30) Foreign Application Priority Data
Dec. 24, 2018 (GB) 1821211.8

(51) Int. Cl. C01G 49/08; H01F 1/34; G06F 3/041

(52) U.S. Cl. CPC C01G 49/08; H01F 1/342; G06F 3/0414; C01P 2004/51; G06F 2203/04103; C01P 2004/62; C01P 2004/90; C01P 2006/40; C01P 2004/61

(57) ABSTRACT

A method of controlling the electrical properties of a quantity of magnetite particles comprises the step of oxidising at least some of the quantity of magnetite particles by heating the said quantity of magnetite particles in an oxygen rich environment for a period of time.

This invention outlines a means of controlling the electrical properties of magnetite particles with a specified morphology to enable their use in a range of electronic devices where the electrical response of magnetite to a pressure stimulus is a primary factor. The stimulus can be a mechanical force or pressure or an electrical force in the form of a voltage. It has been found that the inherent electrical force versus resistance (FvR) response of magnetite composites is altered by the selection of the magnetite particle sizes or by the addition of other particles with different morphologies or levels of electrical conduction.

It would be beneficial if the electrical properties of the magnetite particles could be altered other than by the process of selection of sizes or the addition of other particle types. This can be important if the requirement is for lower response sensitivities of magnetite as the smallest sizes are sometimes too electronically sensitive for the task required especially when used in thin films. The increased sensitivity resulting from the thin magnetite layer can give a resistance change to an applied force which is too large or too rapid for a particular task. By reducing the sensitivity of the magnetite a material comprising magnetite particles can be made to respond to similar changing forces with a slower resistance change and/or with a change in the range of resistance response.

It is known that heating magnetite to specified temperatures for specified time periods can change the chemical and structural properties of magnetite.

Surprisingly, it has been found that by oxidising the magnetite the electrical sensitivity of a composition formed using such oxidised magnetite can be reduced, thereby allowing the electrically anisotropic properties of compositions including magnetite (that is localised change in resistance of the composition around the point of application of a force) to be used in applications where previously their sensitivity constrained their use.

According to a first aspect of the invention there is provided a method of controlling the electrical properties of a quantity of magnetite particles comprising the step of oxidising at least some of the quantity of magnetite particles by heating the said quantity of magnetite particles in an oxygen rich environment for a period of time.

Preferably, the quantity of magnetite particles is heated to 200 C.

It is known that when magnetite is heated in an oxygen rich environment the magnetite oxidises further and the type of oxidation depends on the temperature to which the magnetite is heated.

The magnetite may be heated to a selected temperature between 200 C and 250 C. The magnetite may be heated to a selected temperature of up to 375 C, or to any selected temperature between 200 C and 400 C.

The magnetite may be heated to a selected temperature of between 375 C and 550 C.

The magnetite may be heated to a selected temperature of between 550 C to 575 C.

Preferably, the oxygen rich environment is air. The environment may be oxygen enriched, having a greater proportion of oxygen than air.

It has been found that period of time that the quantity of magnetite particles is heated influences the extent to which the quantity of magnetite particles is oxidised. If the heating period is very short, for example only a few seconds, it is likely that only the outermost particles in the quantity of magnetite particles will be oxidised, and the particles that are oxidised may only be oxidised on their surfaces. As the heating period is increased a greater proportion of the quantity of magnetite is oxidised (to the extent that all the particles in the quantity of magnetite may be oxidised) and the depth of oxidation of the particles from their surface increases. This process may be enhanced by means which provide for an oxidising atmosphere to reach the surfaces of as many of the magnetite particles as possible. This may be achieved by agitating the magnetite, for example by blowing heated oxidising air or other oxidising gas through the heated magnetite, or by rotating the magnetite in a drum whilst exposing the magnetite to a suitable oxidising atmosphere.

The extent of oxidation of the magnetite particles has been found to affect the sensitivity of resistance change in relation to applied force.

Preferably, the magnetite particles are heated for between 1 minute and 240 minutes, more preferably between 5 and 120 minutes. The magnetite particles may be heated for between 5 and 60 minutes or between 5 and 45 minutes. In one example magnetite particles are heated from 10 minutes, in another example for 30 minutes and in a further example for 45 minutes.

It is preferred that the magnetite particles have a plurality of planar faces, adjacent planar faces connected at a vertex, the particles each having a plurality of vertices wherein the magnetite particles are irregular in shape and have a low aspect ratio.

Advantageously, the magnetite is naturally occurring magnetite although synthetic magnetite may be used.

Preferably, the quantity of magnetite particles includes a distribution of particle sizes between sub-micron and tens of microns. The distribution may include particles having sizes between sub-micron and tens of microns at d50.

Preferably, the magnetite particles are of a selected size or in a distribution of selected sizes. The magnetite particles may all be of sub-micron size. The largest magnetite particles may be not more than 250 micron.

The particle size distribution may be selected using known particle size classification techniques. Such techniques may be used to provide very narrow particle size distributions or conversely relatively wide particle size distributions.

Advantageously, the shape of the first electrically conductive particles in the distribution fall under the particle shape definitions of, “oblate”, that is tabular, and/or “bladed”, that is a flat or elongated shape form. Where the magnetite is synthetic its shape may be spherical or acicular, or any other shape that may be formed in the process for manufacturing synthetic magnetite.

The distribution of particle size of the first electrically conductive particles at d₅₀ may be between 50 and 75 micron and preferably, the distribution of particle size of the first electrically conductive particles at d₅₀ is between 60 and 65 micron, and more preferably the distribution of particle size of the first electrically conductive particles at d₅₀ is be between 20 and 25 micron, and still more preferably, the distribution of particle of the first electrically conductive particles size at d₅₀ is be between 5 and 15 micron, and yet more preferably, the particle size of the first electrically conductive particles at d₅₀ is 10 micron.

Advantageously, the distribution of particle sizes between sub-micron and tens of microns in the quantity of magnetite particles includes sub-micron sized particles and particles that are tens of microns in size.

According to a second aspect of the invention there is provided a material responsive to an applied force, the material comprising at least a first electrically conductive filler and a non-conductive filler containment matrix, wherein the conductivity of the material in an unstressed state is related to the conductivity of the at least one substantially non-conductive filler containment matrix and in a stressed state to the conductivity resulting from the presence of the at least first electrically conductive filler in the material, characterised in that the first electrically conductive filler is comprised of magnetite particles and wherein at least some of the magnetite particles are the product of the method of the first aspect of the invention.

The non-conductive filler containment matrix may be a binder, a textile such as a non-woven assembly of fibres which may be in a yarn or a roving, a surface to which the electrically conductive filler may adhere, or an open or closed cell foam which may be formed by loading the foam material prior to foaming, or applying a coating the finished foam The binder may be a polymer binder, a grease, an oil, a gel or a wax.

The at least one first electrically conductive filler may be provided on the non-conductive filler containment matrix as a thin film, for example as a surface layer on the non-conductive foam or a textile.

The applied force to which the material is responsive may be due to mechanical or electrical forces.

According to a third aspect of the invention there is provided a composite material responsive to applied force, the composite material comprising at least one substantially non-conductive binder and at least a first electrically conductive filler, wherein the conductivity of the composite material in an unstressed state is related to the conductivity of the at least one substantially non-conductive binder and in a stressed state to the conductivity resulting from the presence of the at least first electrically conductive filler in the composition, characterised in that the first electrically conductive filler is comprised of magnetite particles and wherein the composite material is configured for laying down on a substrate in a thin film.

The applied force to which the material is responsive may be due to mechanical or electrical forces.

In the context of this invention a thin film may have a thickness from fractions of a nanometer to micrometers.

Preferably, the proportion of magnetite to binder is 1:199 to 97:3 magnetite to binder by weight.

The binder may be substantially transparent. The proportion of magnetite to binder may be between 1 to 199 and 10 to 90. Preferably, the proportion of magnetite to binder is between 5 to 95 and 1 to 99 by weight and more preferably 2 to 98 by weight.

Preferably, the at least one binder is a polymer binder. For example, water based polyurethane thinned with water up to 5 parts water to 1 part polyurethane. Silicone, can be thinned down 10 parts thinner (a suitable thinner such as white spirit) to 1 part silicone.

It is preferred that the magnetite of the electrically conductive filler is the product of the method of the first aspect of the invention.

It is preferred that the magnetite particles have a plurality of planar faces, adjacent planar faces connected at a vertex, the particles each having a plurality of vertices wherein the magnetite particles are irregular in shape and have a low aspect ratio.

Preferably, the quantity of magnetite particles includes a distribution of particle sizes between sub-micron and tens of microns. The distribution may include particles having sizes between sub-micron and tens of microns at d50.

Preferably, the magnetite particles are of a selected size or in a distribution of selected sizes. The magnetite particles may all be of sub-micron size. The largest magnetite particles may be not more than 250 micron.

The particle size distribution may be selected using known particle size classification techniques. Such techniques may be used to provide very narrow particle size distributions or conversely relatively wide particle size distributions.

Advantageously, the shape of the first electrically conductive particles in the distribution fall under the particle shape definitions of, “oblate”, that is tabular, and/or “bladed”, that is a flat or elongated shape form.

The distribution of particle size of the first electrically conductive particles at d₅₀ may be between 50 and 75 micron and preferably, the distribution of particle size of the first electrically conductive particles at d₅₀ is between 60 and 65 micron, and more preferably the distribution of particle size of the first electrically conductive particles at d₅₀ is be between 20 and 25 micron, and still more preferably, the distribution of particle of the first electrically conductive particles size at d₅₀ is be between 5 and 15 micron, and yet more preferably, the particle size of the first electrically conductive particles at d₅₀ is 10 micron.

Advantageously, the distribution of particle sizes between sub-micron and tens of microns in the quantity of magnetite particles includes sub-micron sized particles and particles that are tens of microns in size.

According to a fourth aspect of the invention there is provided a thin film of the composite material of the third aspect of the invention laid down on a substrate, wherein the minimum depth of the film is the dimension of the largest particle, for example a magnetite particle, in the composite measured in the direction of the depth of the film.

Thin films may have thicknesses of between 1 micron and 50 microns or between 1 micron and 20 microns for example.

The thin film may have a maximum thickness of 0.25 mm.

The thin film may be laid down on the substrate in a single layer, or in multiple layers. It has been found that increasing the layer thickness and increasing the number of layers decreases sensitivity of response to the application of applied force.

The thin film of the fourth aspect of the invention may be a layer of a touch screen, and the layer may be substantially transparent.

According to a fifth aspect of the invention there is provided a touch screen comprising a thin film of the fourth aspect of the invention, the thin film forming a layer of the touch screen. Preferably, the layer is substantially transparent.

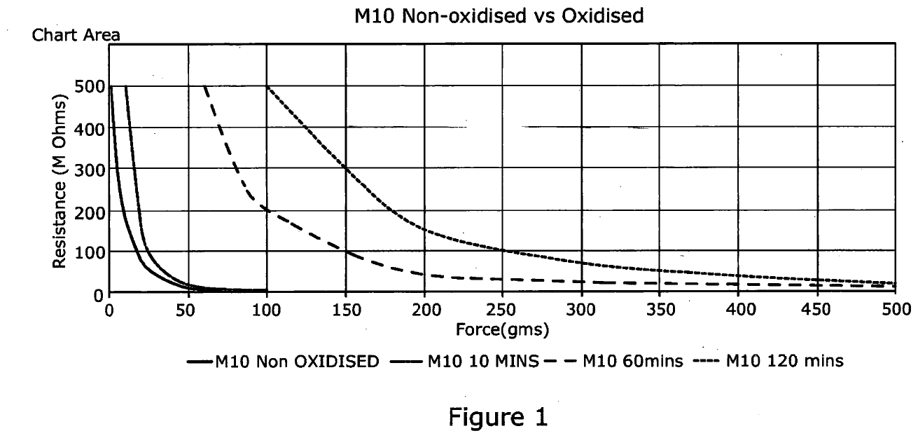

FIG. 1 is a graph showing the relationship between resistance and pressure for compositions formed using LKAB's M10 magnetite (example 1, table 1) when heated to 250 C for different periods of time.

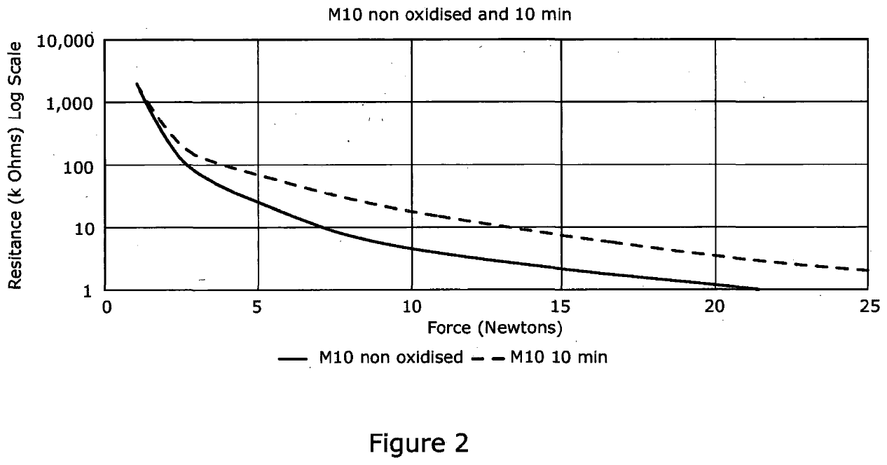

FIG. 2 is a graph showing the relationship between resistance and pressure for compositions formed using LKAB's M10 magnetite (example 1, table 1) respectively when heated to 250 C for 10 minutes and when the same magnetite is not oxidised.

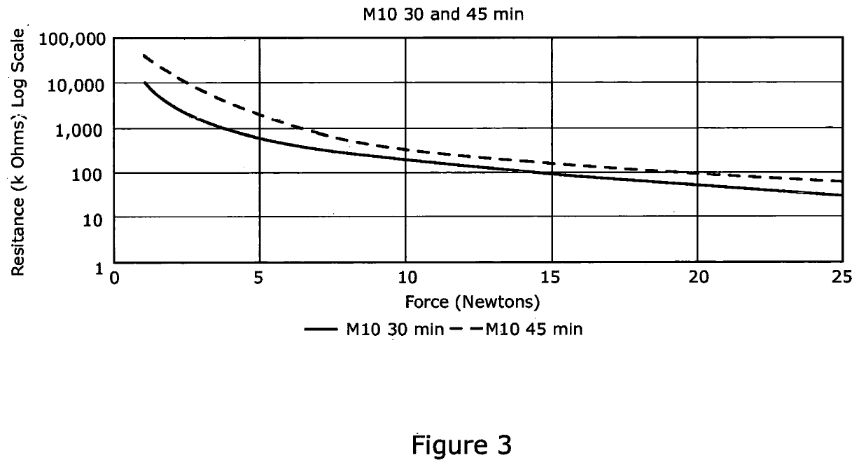

FIG. 3 is a graph showing the relationship between resistance and pressure for compositions formed using LKAB's M10 magnetite (example 1, table 1) respectively when heated to 250 C for 30 minutes and 45 minutes and when the same magnetite is not oxidised.

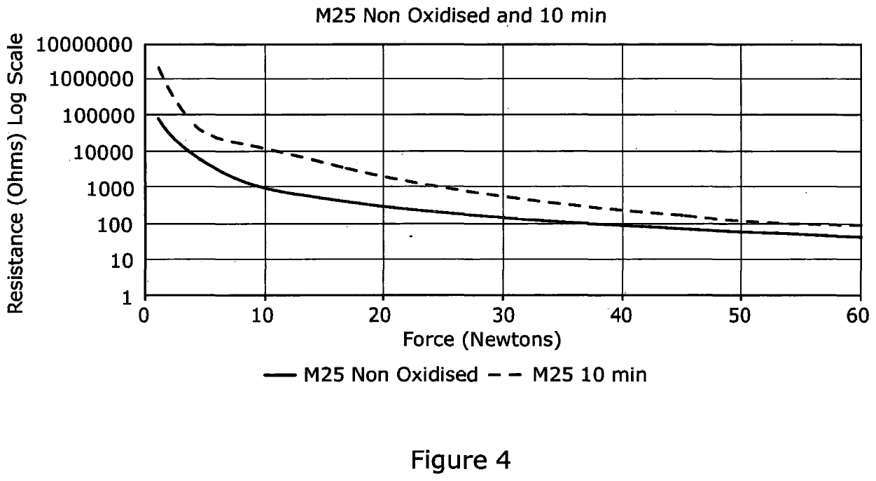

FIG. 4 is a graph showing the relationship between resistance and pressure for compositions formed using LKAB's M25 magnetite (example 2, table 1) respectively when heated to 250 C for 10 minutes and when the same magnetite is not oxidised.

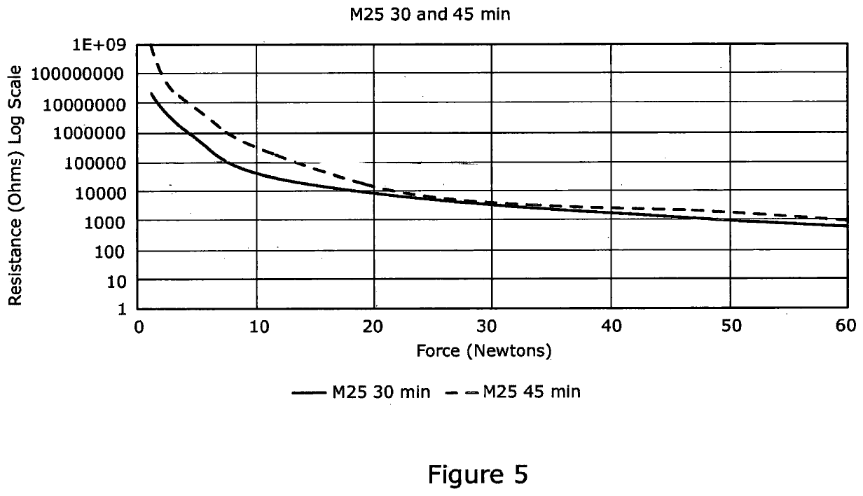

FIG. 5 is a graph showing the relationship between resistance and pressure for compositions formed using LKAB's M25 magnetite (example 2, table 1) respectively when heated to 250 C for 30 minutes and 45 minutes and when the same magnetite is not oxidised.

In each example the magnetite was mixed with a binder in a low shear mixing regime, the binder being a water-based polyurethane binder.

The proportion of magnetite to binder was 3:1 by weight. The resulting composition was laid down on an open weave mesh in a layer approximately 0.25 mm thick. Forces were applied to the sample by a gold plated electrode rod of a circular cross-cross-section having a diameter of 6 mm against a stainless steel electrode plate, the composition being between the stainless steel base plate and the electrode.

LKAB of Sweden provide natural magnetite of different particle sizes which has been used in this invention. Alternatively, natural magnetite from New Zealand has been found to work in the invention when comminuted and sized and sorted by sieving.

Table 1 below sets out four different types size distributions of magnetite available from LKAB.

TABLE 1

| Particle size | | | | |
|---|---|---|---|---|
| distribution | Example 1 | Example 2 | Example 3 | Example 4 |
| (cyclosizer | Magnetite - | Magnetite - | Magnetite - | Magnetite - |
| method) | Magnif 10 | Magnif 25 | Magnif 50 | Magnif EX014 |
| d10 (micron) | 5 | 6 | 9 | 3 |
| d50 (micron) | 10 | 22 | 63 | 7 |
| d90 (micron) | 25 | 50 | 180 | 13 |
| particle | irregularly shaped, | irregularly shaped, | irregularly shaped, | irregularly shaped, |
| characteristics | low aspect ratio | low aspect ratio | low aspect ratio | low aspect ratio |

It can be seen from the graphs that by increasing the oxidation of magnetite the sensitivity of the composition formed therewith is reduced. It can also be seen from the graphs that where the particle size of the magnetite is smaller there is a greater reduction in sensitivity by heating the magnetite for a longer time period.

The increased range of response sensitivity which results from this oxidising process provides a large increase in the number of achievable mixing ratios and sensitivities of composites and allows the formulation of thinner FvR composite lay-downs.

The LKAB magnetite particles used in this invention range in size between sub-micron and tens of microns at D50. The particles are produced by a pulverisation process and have irregular shapes described as each having a plurality of planar faces, adjacent planar faces connected at a vertex, the particles each having a plurality of vertices.

Although the overall range of the resistance change in response to applied force may be reduced somewhat, the reduction in response sensitivity can still provide a large range of resistance change in response to an input of force which can be useful for the detection of larger applied forces and activation by different voltages.

There are a number of ways of heating the magnetite include heating it in an electric element oven or using induction or microwave heating. An electric element oven was used for the oxidation of the magnetite used for making the graphical examples.

Polymers with different mobilities can be used with different magnetite particle sizes to produce composites with different final sensitivities. The thickness and mobility of the matrix also has an effect on the working sensitivity of the composite. In thin matrixes with low particle loadings individual magnetite particles may be some distance apart and it is possible to use polymers with a lower mobility as the sensitivity of the composite will increase as the composite laydown is reduced in thickness. Thin lay-downs of composites with very low loadings of the smaller magnetite particles can use clear polymer binders to provide the active pressure component of transparent and translucent touch-panels and screens. By using an electrically anisotropic pressure sensitive material, it is possible to measure the force a user applies, and the x, y location of the applied force, when touching the screen.

A substantially transparent thin film can be obtained with a proportion of 2% magnetite to 98% binder. However, loadings of magnetite in thin composite lay-downs can be as low as 0.5% (by weight) of the composite. In thicker composites, high-mobility matrixes such as gels can be loaded with magnetite up to levels of approximately 97% (by weight) which is well beyond the accepted percolation level of magnetite. Mixing of both high and low loadings of magnetite into the matrixes is done using controlled, low-shear mixing regimes to reduce or eliminate the effect of aggregation of the particles on the electrical qualities of the composite.

In order to provide a composite having the desired sensitivity, that is change in resistance in response to the application of pressure, the particles can be sorted into individual sizes and/or mixed ranges of sizes prior to incorporation into a matrix, typically a binder. The invention provides a simple process which alters the magnetite's inherent range of sensitivity prior to its incorporation in a matrix. This is achieved by heating the magnetite in an oxygen rich environment for a period of time.

1. A method of controlling the electrical response sensitivity of a quantity of magnetite particles, the magnetite particles each having a plurality of planar faces, adjacent planar faces connected at a vertex, each particle having a plurality of vertices wherein the magnetite particles are irregular in shape and have a low aspect ratio, the method characterised by the step of oxidising at least some of the quantity of magnetite particles by heating the said quantity of magnetite particles in an oxygen rich environment for a period of time, wherein the electrical response sensitivity of the so oxidised quantity of magnetite to a force stimulus is reduced relative to an electrical response sensitivity to the same force stimulus of quantity of said magnetite particles which have not been so oxidised.

2. A method according to claim 1, wherein, the quantity of magnetite particles is heated to a selected temperature of one of: 200 C; up to 375 C; between 200 C and 250 C; between 200 C and 400 C; between 375 C and 550 C; and between 550 C to 575 C.

3. A method according to claim 1, wherein the force stimulus is a selected one of: mechanical; electrical; and mechanical and electrical.

4. (canceled)

5. (canceled)

6. (canceled)

7. (canceled)

8. A method according to claim 1, wherein the oxygen rich environment is air or an environment that is enriched with oxygen, the oxygen rich environment having a greater proportion of oxygen than air.

9. A method according to claim 1, wherein the magnetite particles are heated for a selected period of time of: between 1 minute and 240 minutes; between 5 and 120 minutes; between 5 and 60 minutes; between 5 and 45 minutes; 10 minutes; 30 minutes; and 45 minutes.

10. A method according to claim 1, wherein the electrical response sensitivity that is reduced is selected from the group comprising: a rate of change of resistance of the quantity of so oxidised magnetite in response to the force stimulus; and a resistance range of the quantity of so oxidised magnetite in response to the force stimulus.

11. A method according to claim 1, wherein the quantity of magnetite particles includes a distribution of particle sizes between sub-micron and tens of microns.

12. A method according to claim 11, wherein the distribution of particle sizes between sub-micron and tens of microns in the quantity of magnetite particles includes sub-micron sized particles and particles that are tens of microns in size.

13. An electrically anisotropic material responsive to applied force, the material comprising at least a first electrically conductive filler and a non-conductive filler containment matrix, wherein the conductivity of the material in an unstressed state is related to the conductivity of the non-conductive filler containment matrix and in a stressed state to the conductivity resulting from the presence of the at least first electrically conductive filler in the material, characterised in that the first electrically conductive filler is comprised of magnetite particles and wherein at least some of the magnetite particles are the product of the method of controlling the electrical response sensitivity of a quantity of magnetite particles, the magnetite particles each having a plurality of planar faces, adjacent planar faces connected at a vertex, each particle having a plurality of vertices wherein the magnetite particles are irregular in shape and have a low aspect ratio, the method characterised by the step of oxidising at least some of the quantity of magnetite particles by heating the said quantity of magnetite particles in an oxygen rich environment for a period of time, wherein the electrical response sensitivity of the so oxidised quantity of magnetite to a force stimulus is reduced relative to an electrical response sensitivity to the same force stimulus of quantity of said magnetite particles which have not been so oxidised.

14. A material according to claim 13, wherein the non-conductive filler containment matrix is one of: a binder; a textile; a textile in the form of a non-woven assembly of fibres; a textile in the form of a non-woven assembly of fibres which is a yarn or a roving; a surface to which the electrically conductive filler may adhere; or an open or closed cell foam.

15. A material according to claim 14, wherein the material is formed by loading a selected one of: an open cell foam with the electrically conductive filler prior to foaming a closed cell foam with the electrically conductive filler prior to foaming; by applying a coating of the electrically conductive filler to a finished foam.

16. A material according to claim 14, wherein the binder is of a selected one of: a polymer binder; a grease; an oil; a gel and a wax.

17. A material according to claim 13, wherein the at least one first electrically conductive filler is provided on the non-conductive filler containment matrix as a thin film.

18. A material according to any of claim 13, wherein the applied force to which the material is responsive is a selected one of: mechanical; electrical; and mechanical and electrical.

19. (canceled)

20. (canceled)

21. (canceled)

22. (canceled)

23. (canceled)

24. (canceled)

25. (canceled)

26. (canceled)

27. An electrically anisotropic material according to claim 13 laid down on a substrate as a thin film, wherein the minimum depth of the film is the dimension of the largest magnetite particle measured in the direction of the depth of the film.

28. An electrically anisotropic material according to claim 27, wherein the thin film has a maximum thickness of 0.25 mm.

29. An electrically anisotropic material according to claim 27, wherein the thin film is laid down on the substrate in a selected one of: a single layer, and multiple layers.

30. A touch screen comprising an electrically anisotropic material according to claim 27, the thin film forming a layer of the touch screen.

31. A touch screen according to claim 30, wherein the layer is substantially transparent.

32. A method according to claim 1, comprising the further step of incorporating the so oxidised quantity of magnetic into a matrix.

33. The combination of magnetite particles produced according to the method of claim 1, and a matrix, the magnetite particles incorporated into the matrix.
